(19) United States
(12) Patent Application Publication
(10) Pub. No.: US 2007/0051045 A1
(43) Pub. Date: Mar. 8, 2007

(54) Door drive housing

(76) Inventor: Michael Hoermann, Halle/Westf (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/512,729

(22) Filed: Aug. 29, 2006

(30) Foreign Application Priority Data
Aug. 31, 2005 (DE) 20 2005 013 766.9

(51) Int. Cl. E05F 15/10

(52) U.S. Cl. 49/199

(57) ABSTRACT

The present disclosure relates to a door drive housing comprising a base support body, preferably of shell shape, and a covering hood which can be connected to the base support body, wherein a base plate made as a sheet metal part can be inserted into the base support body consisting of plastic for the reception of the different drive components.

### CROSS-REFERENCE TO RELATED APPLICATION

This application claims priority to German Utility Model Application Serial No. 20 2005 013 766.9 filed Aug. 31, 2005, which is hereby incorporated by reference in its entirety for all purposes.

### FIELD

The present disclosure relates to a door drive housing comprising a preferably shell-shaped base support body and a covering hood which can be connected to the base support body.

### BACKGROUND AND SUMMARY

Door drives such as garage door drives are typically arranged in a housing which is fastened to the ceiling inside the garage in the case of a garage door drive. As a rule, the drive motor and a transmission are arranged in the housing and said transmission drives a carriage via a chain or belt, said carriage running in a rail connected to the housing. The garage door is fastened to the carriage so that the former can be opened and closed.

As a rule, known door drive housings have a base support body, preferably of shell shape, to which the different drive components are directly fastened. They are then covered by a covering hood which can be connected to the base support body. As a rule, different housings are used for differently configured door drives in order here to be able to make available housings which are as small in construction as possible for a specific drive.

Since this brings about comparatively high costs in practice, since a separate housing has to be produced and kept in stock for every drive type, DE 203 03 315 U1 has already proposed providing a housing extension for the reception of further or larger drive components which can be releasably connected to the base support body in a precise fit. A module-like set-up is thereby already made possible in which a plurality of housing modules, from which the housing can be composed in accordance with the drive components to be used in each case, can be connected to form a total housing.

Both the shell-shaped base support body and the covering hood usually consist of plastic. This door driving housing consisting of plastic has two functions, namely a supporting function for the arrangement of the respective drive components and a housing protection function.

Due to the supporting function for the drive components, in particular the base support body has to be produced precisely. This means that the corresponding assembly bores for the drive components have to be produced precisely, that is while observing narrow tolerances.

The object of the present disclosure consists of further developing the known gate drive housing such that it can be manufactured simply and in a cost-effective manner.

This object is solved in accordance with the present disclosure by a door drive housing comprising a preferably shell-shaped base support body and a covering hood which can be connected to the base support body is provided in which a base plate made as a sheet metal part is inserted into the base support body comprising plastic for the reception of the different drive components. A functional separation of the support function and of the housing protection function is therefore made here. The supporting function is transferred to the base plate made as a sheet metal part, whereas the housing protection function remains with the base support body consisting of plastic and with the covering hood. The present disclosure therefore makes use of the fact that a corresponding sheet metal part can be provided much more simply with precisely arranged assembly bores for the drive components. A corresponding sheet metal part also maintains its shape stability so that the correct association of the respective drive components with one another is ensured after the installation of the drive components.

Accordingly, the base plate can have assembly bores for the drive components to be received.

Furthermore, the base plate can have regions which are bent perpendicularly - so-to-say like tongues - and which can be plugged into corresponding assembly slots of the base support body. A simple assembly of the base plate and the base support body is thereby possible.

In accordance with a further advantageous aspect of the present disclosure, housing extensions can be attached to the base support body. This preferred aspect of the present disclosure takes up the idea of DE 203 03 315 U and also permits a corresponding modular construction in the door drive housing with a base plate made as a sheet metal part to support the different drive components.

It is finally possible for the base plate to be pre-installed with the drive components as a core assembly which can then be inserted into a desired housing. In this connection, different housings can be selected consisting of base support bodies or covering hoods differing with respect to their shape or color.

### BRIEF DESCRIPTION OF THE FIGURES

Further features, details and advantages of the present disclosure result from an embodiment shown in the drawing. There are shown:

FIG. 1 is a perspective total view of the part of a door drive housing with a pre-installed core assembly and a shell-shaped base support body pulled toward one another in a view from above;

FIG. 2 shows a representation in accordance with FIG. 1 in a view from below;

FIG. 3 shows a view from above of the attachment group inserted in the base support body in a view from above; and

FIG. 4 shows the shell-shaped base support body with inserted core assembly shown from below.

### DETAILED DESCRIPTION

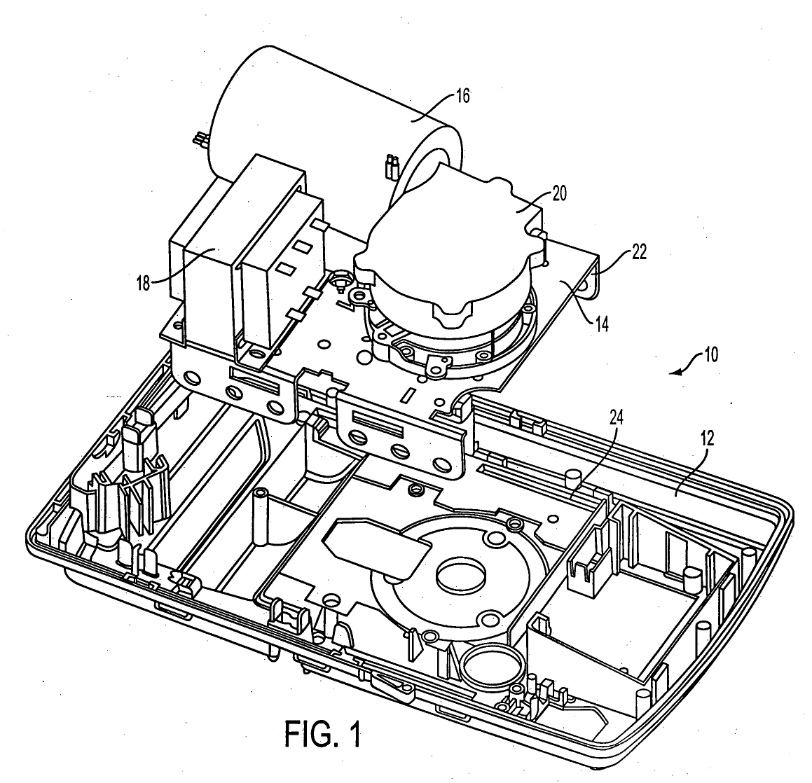

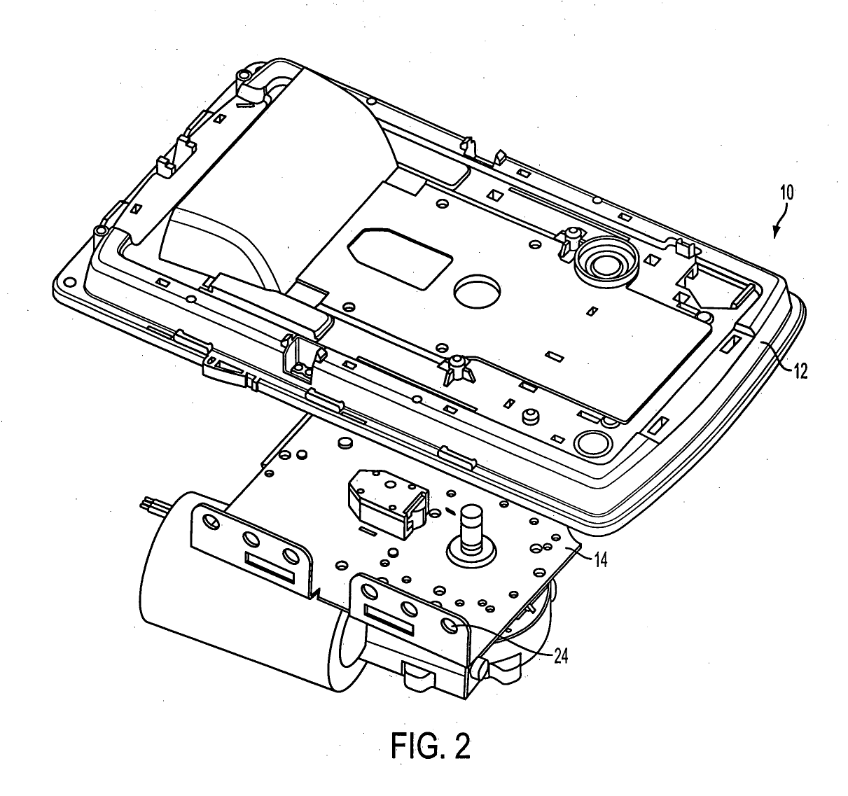

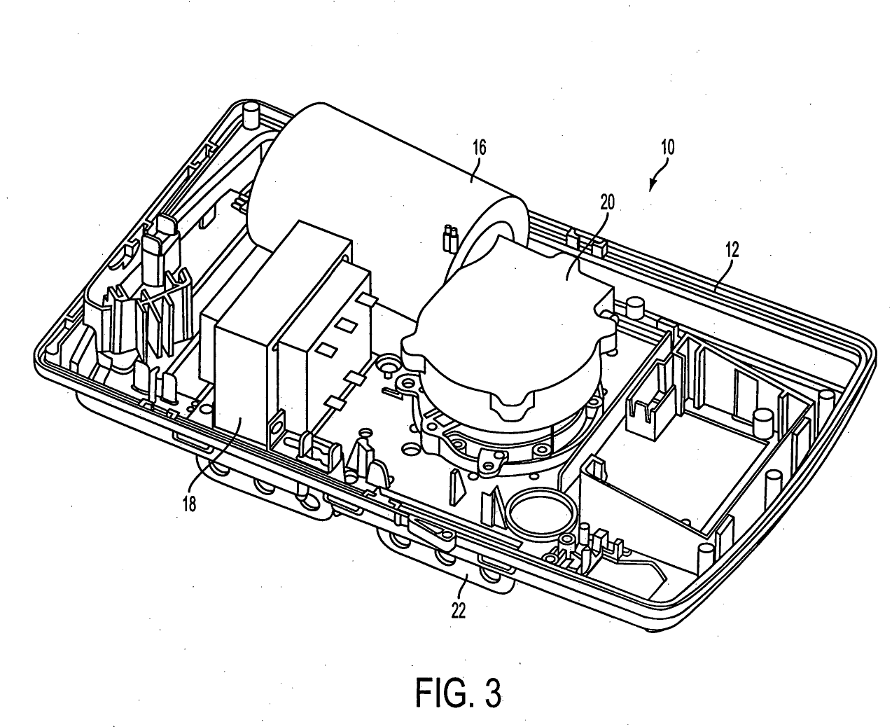

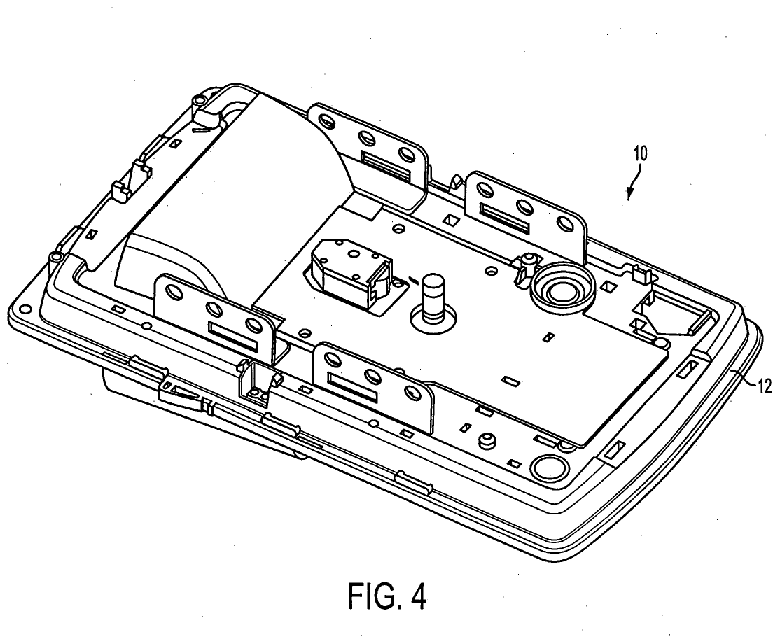

The door drive 10 in accordance with the FIGS. 1 to 4 first comprises a shell-shaped base support body 12 which is made from plastic. A covering hood can be placed onto this which is not shown in any more detail here. Furthermore, a base plate 14 made as a sheet metal part is shown in FIG. 1. The individual drive components such as a motor 16, a transformer 18 and a transmission 20 are arranged here on the base plate 14 made as a sheet metal part. These drive components are each connected to the base plate via corresponding assembly bores in the base plate 14.

The base plate 14 has regions 22 which are respectively bent perpendicularly and which form tongue-like projections. These bent regions 22 can be plugged through corresponding reception slots 24 in the base support body 12. The base plate 14 can hereby be connected to the base support body in a precise position. The total door drive housing 10 can be connected via the bent regions 22 and the assembly bores 24 provided in them to a rail, not shown in any more detail here, for the reception of the carriage moving the door. It is hereby ensured that all supporting functions are taken over by the base plate 14 made as a sheet metal part, whereas the purely housing protection function is taken over by the base support body made of plastic or by the covering hood not shown in any more detail here.

1. A door drive housing comprising:
a base support body comprised of plastic, and
a covering hood configured to be connected to the base support body; and a base plate made as a sheet metal part configured to be inserted into the base support body, said base plate configured for reception of different drive components.

2. The door drive housing in accordance with claim 1, wherein the base plate has assembly bores for the drive components to be received.

3. The door drive housing in accordance with claim 1, wherein the base plate has regions which are bent perpendicularly and which are configured to be plugged into corresponding assembly slots of the base support body.

4. The door drive housing in accordance with claim 1, wherein housing extensions are attached to the base support body.

5. The door drive housing in accordance with claim 1, wherein the base plate is configured to be pre-installed with the drive components as a core assembly.

6. The door drive housing in accordance with claim 1, wherein said base support body has a shell shape.

7. A door drive housing, comprising:
a base support body comprised of plastic, and
a covering hood connected to the base support body, both said base support body and said covering hood protecting the housing; and
a sheet metal base plate inserted into the base support body supporting a drive component coupled to and received in said base plate.

8. The door drive housing in accordance with claim 7, wherein the base plate has assembly bores for the drive components to be received.

9. The door drive housing in accordance with claim 8, wherein the base plate has regions which are bent perpendicularly and which are plugged into corresponding assembly slots of the base support body.

10. The door drive housing in accordance with claim 9, wherein housing extensions are attached to the base support body.

11. The door drive housing in accordance with claim 10, wherein the base plate is pre-installed with the drive component as a core assembly.

12. The door drive housing in accordance with claim 10, wherein said base support body has a shell shape.

13. A door drive housing, comprising:
a base support body comprised of plastic, and
a covering hood connected to the base support body, both said base support body and said covering hood protecting the housing; and
a sheet metal base plate inserted into the base support body supporting a plurality of associated drive components coupled to and received in said base plate, said base plate having precisely arranged assembly bores for the drive components and having sufficient shape stability so that the correct association of the respective drive components with one another is maintained after the installation of the drive components.
